(19) United States
(12) Patent Application Publication
(10) Pub. No.: US 2004/0093409 A1
(43) Pub. Date: May 13, 2004

(54) System and method for external event determination utilizing an integrated information system

(75) Inventors: Paul Thompson, Poulsbo, WA (US); David Antal, Silverdale, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Vigilos, Inc.

(21) Appl. No.: 10/291,920

(22) Filed: Nov. 7, 2002

(51) Int. Cl. G06F 15/173

(52) U.S. Cl. 709/224

(57) ABSTRACT

A system and method for accepting an external event determination into a network-based integrated information system is provided. Once accepted, an external event determination is processed by the integrated information system as the system equivalent of a device-generated event. The system captures a record of the external event determination and generates an event resolution sequence, which may include the generation (and escalation) of notifications to one or more notification acceptors. The external event determination may further activate one or more devices within a monitored premises. At least one of the external event determination steps is accomplished over an Internet-based communications network. Transmitted device data is encrypted by each node within the integrated information system to ensure data security.

### FIELD OF THE INVENTION

The present invention relates generally to device monitoring and control, and in particular, to a system and method for external event determination utilizing a rules-based integrated information system.

### BACKGROUND OF THE INVENTION

Generally described, physical security systems perform a range of monitoring and control functions. A security system may include a number of subsystems designed to monitor and control physical security through the use of devices for access control, video monitoring, intrusion detection, and the like. In some security configurations, a system may be linked to transaction-related components, such as bar code readers, smart cards, or point-of-sale devices. While the conventional art discloses the use of multiple devices to perform various monitoring and control functions, conventional systems are deficient in distributed data management functionality and integration. Generally, security data from different monitoring device types or systems is not integrated to enable centralized system reporting apart from customized, site-specific deployments.

In one aspect, visual security surveillance, historically provided by on-site guards or tape-based video recording systems, is gradually being supplanted by digital video recorders. Digital video recorders (“DVRs”) allow video to be recorded, accessed, and stored using computer network devices. Recorded video is stored in retrievable file formats and may be accessed over computer networks. In some instances, a DVR may be addressable over an Internet protocol network using an Internet protocol (“IP”) address or may be further equipped with server software components to send and receive data to and from clients over the World Wide Web (the “Web” or “WWW”).

DVRs are operable to record video in three modes: continuous, scheduled, or event-based. Continuous video recording allows the DVR to record video twenty-four hours a day, seven days a week. Scheduled recording allows the DVR to record video during scheduled periods, such as Monday to Friday from 8:00 to 6:00. Event-based recording initiates the collection of video in response to a detected change in a device. In DVR systems, event-based recording typically relates to initiating recording based on the detection of motion. For example, a DVR may record data if a comparison of video frame data indicates a variance between two successive frames of data (e.g., the detection of motion).

Generally described, continuous digital video recording consumes a large amount of storage space and network bandwidth as compared to other data. Additionally, continuously transmitted (“streamed”) video cannot be transmitted securely without adding additional encryption and decryption processing layers to the video encoding, decoding, and transmittal processes, and consuming additional bandwidth and processing capacity. Accordingly, continuous digital video recording can place a great strain on processing and memory resources.

To mitigate deficiencies associated with continuous digital video recording, a DVR system may be configured for scheduled and/or event-based recording. Although scheduled and/or event-based recording potentially reduce the amount of required storage space, the risk of omitting critical data increases. For example, in a scheduled recording environment, events that occur outside of scheduled recording parameters may not be captured by the DVR. Likewise, incidents not classified as an “event” in an event based format may also be omitted. For example, if a clarification of a recordable “event” is narrowly defined, the DVR may fail to record an a typical event situation. Accordingly, potentially high-value video may be lost.

In one aspect, DVRs may be used in connection with live, guard-based monitoring to provide remote security surveillance. In a continuous recording environment, a guard may have access to real-time video streamed over a network to a remote site, and as noted above, if such video is unencrypted, it may be vulnerable to unauthorized access. However, a continuous recording format can require very high bandwidth and storage space. In an event-based format or a scheduled recording format, a guard may have access to a video stream that is not being recorded (e.g., if it is outside of scheduled recording hours, or unrelated to a system-identified event). In either circumstance (continuous or programmatic recording) the converted DVR system does not provide any mechanism or interface to enable a guard to control or initiate the recording of video in response to an observed or perceived security event. Accordingly, a guard cannot remotely initiate the recording of video without providing a direct physical connection to a video recording device. This limitation prevents experiential or observed data to be externally entered into the DVR system. Additionally, a DVR system provides no manner for accepting an external event determination that would result in the initiation of an event-resolution sequence, such as one or more outputs to other devices or automated notifications.

Based on the also noted deficiencies, there is a need for a system and method for accepting and processing externally generated events.

### SUMMARY OF THE INVENTION

In a rules-based system for monitoring device output over a network, a method and system for external event determination is provided. An information processing system is configured to process monitoring device data according to a number of predefined on dynamically implemented rules. An external component, such as a security guard, other external user of a system, or other external device, determines that an event of interest is occurring. The external component dynamically specifies an event occurrence with the information processing system. The dynamic specification can indicate data for identifying the event, specifying any desired outputs (e.g., recording) event notifications and escalation and severity information related to the specified event.

In accordance with an aspect of the present invention, a method for providing an external event determination is provided. The method may be implemented in an integrated information system having at least one monitoring device providing monitoring device data. The integrated information system includes at least one processing rule for processing monitoring device data. In accordance with the method, a computing device obtains monitoring device data corresponding to a monitored target and at least one processing rule corresponding to the monitoring device data. The computing device processes the monitoring device data according to the at least one processing rule. The computing device obtains an external event notification corresponding to the monitored target and processes the external event notification to determine an event and an integrated information system output. The computing device generates an output corresponding to the processing of the external event notification, wherein the output may include no output.

In accordance with another aspect of the present invention, a system for providing device monitoring is provided. The system includes a processing component having at least one monitoring device providing monitoring device data for a monitored target and at least one processing rule corresponding to the monitoring device. The processing component processes the monitoring device data according to the processing rule. The system also includes at least one external component operable to provide external event notification data corresponding to the monitoring device data to the processing component. The processing component processes the external event notification data to determine a monitoring event and a corresponding output.

In accordance with a further aspect of the present invention, a method for managing external event determinations for an integrated information system is provided. The method may be implemented in a computer system having a display and an interface device, wherein the integrated information system includes at least one monitoring device generating monitoring device data and at least one processing rule corresponding to the monitoring device data. In accordance with the method, a computing device obtains a set of authorized external event notifications corresponding to an external component user. The computing device displays the set of authorized external event notifications on the display. The computing device obtains a user selection of an external event notification. Further, the computing device transmits the user selection of the user event notification.

### BRIEF DESCRIPTION OF THE DRAWINGS

The foregoing aspects and many of the advantages of this invention will become more readily appreciated as the same become better understood by reference to the following detailed description, when taken in conjunction with the accompanying drawings, wherein:

FIG. 1 is a block diagram of an Internet environment suitable for implementing aspects of the present invention;

FIG. 2 is a block diagram of an integrated information system formed in accordance with the present invention;

FIG. 3 is a block diagram depicting an illustrative architecture for a premises server in accordance with the present invention;

FIG. 4 is a block diagram depicting an illustrative architecture for a central server in accordance with the present invention;

FIG. 5 is a flow diagram illustrative of a monitoring device data processing routine in accordance with the present invention;

FIG. 6 is a flow diagram illustrative of a device event processing subroutine in accordance with the present invention;

FIGS. 7A and 7B are flow diagrams illustrating an asset/resource event processing routine in accordance with the present invention;

FIG. 8 is a flow diagram illustrative of an external event determination processing routine in accordance with the present invention; and

FIG. 9 is illustrative of a screen display enabling a user to make an external event determination in accordance with the present invention.

### DETAILED DESCRIPTION OF THE PREFERRED EMBODIMENT

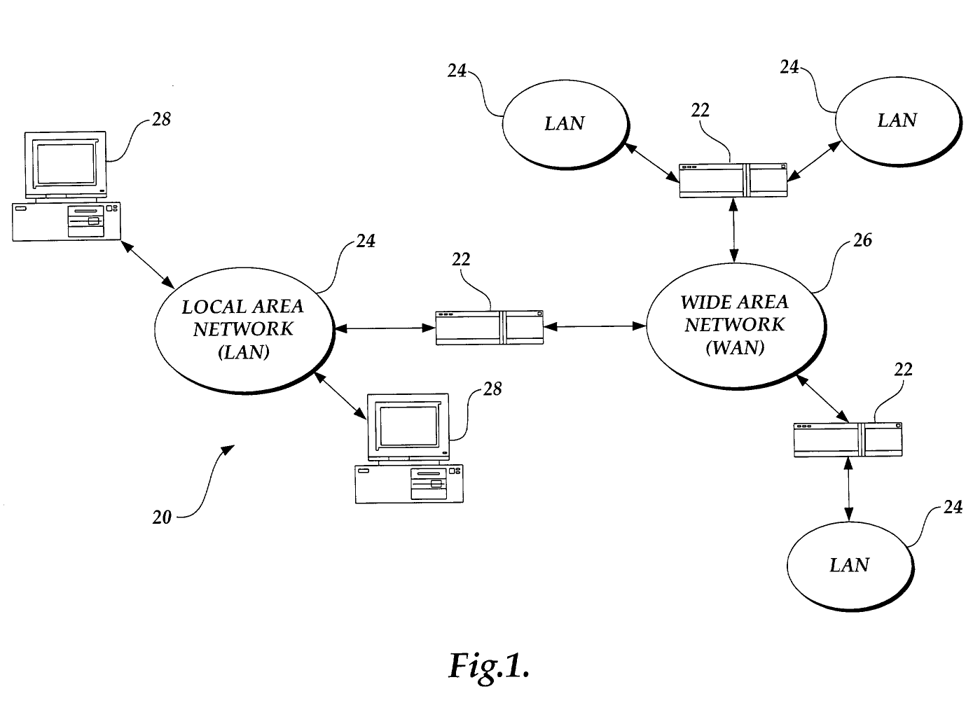

As described above, aspects of the present invention are embodied in WWW or (“Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, in which a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, or coaxial cable, while communication links between networks may utilize 56 Kbps analog telephone lines, 1 Mbps digital T-1 lines, 45 Mbps T-3 lines or other communications links known to those skilled in the art. Furthermore, computers and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1. One skilled in the relevant art will appreciate that aspects of the present invention may be practiced on Internet networks, such as an Intranet.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at Web sites throughout the Internet. A Web site is a server connected to the Internet that has mass storage facilities for storing hypertext documents and that runs administrative software for handling requests for those stored hypertext documents. A hypertext document normally includes a number of hyperlinks, i.e., highlighted portions of text which link the document to another hypertext document possibly stored at a Web site elsewhere on the Internet. A hyperlink is associated with a Uniform Resource Locator (“URL”) for providing the exact location of the linked document on a server connected to the Internet and describing the document. As is known to those skilled in the art, a Web server may also include facilities for storing and transmitting application programs, such as application programs written in the JAVA® programming language from Sun Microsystems, for execution on a remote computer. Likewise, a Web server may also include facilities for executing scripts and other application programs on the WWW server itself. A user may retrieve hypertext documents from the WWW via a Web browser application program or, alternatively by establishing a direct connection to a Web site outside of a Web browser, through an application such as Sun Microsystem's JAVA WEB START, which replicates a client-server relationship within a Web environment.

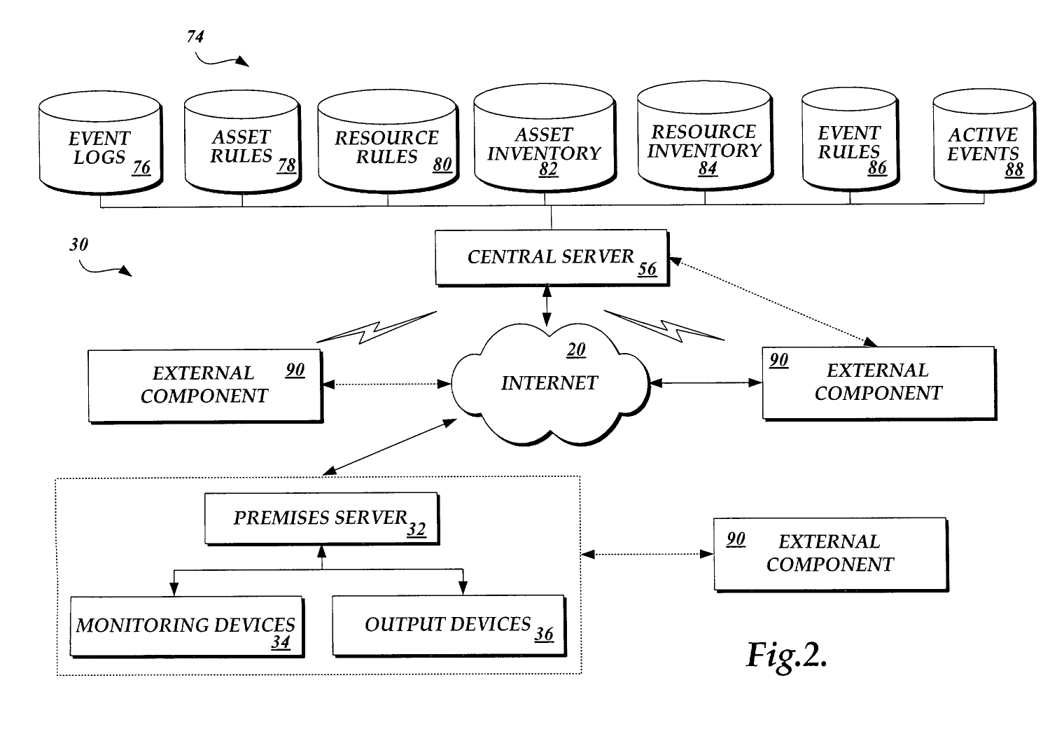

Referring now to FIG. 2, an actual embodiment of an integrated information system 30 in accordance with the present invention will be described. An integrated information system 30 is a subscriber-based system allowing data from a number of devices from one or more monitored targets, to be monitored from remote locations. In an illustrative embodiment of the present invention, the monitored targets include premises corresponding to a geographic location. However, additional monitored targets, such as mobile monitored targets or other fixed monitored targets, may also be utilized in accordance with the present invention. In one aspect, data from the monitoring devices is processed according to one or more processing rules that includes criteria for determining an event. The processing rules may be system specified or user specified. Additionally, the system rules may be predefined or dynamically defined during the processing of data. In another aspect, the system can include an interface for allowing external event determination. The central server customizes the output of the processed data dependent of the determination of an event and a specified set of outputs. While the system of the present invention is utilized to integrate traditional security monitoring functions, it can also be utilized to integrate any information input in a like manner.

With continued reference to FIG. 2, the integrated information system 30 includes a premises server 32 located within a monitored premises. The premises server 32 communicates with one or more monitoring devices 34. In an illustrative embodiment, the monitoring devices 34 can include video cameras, motion sensors, card readers, microphones, biometric devices, environmental monitoring devices, and the like. The monitoring devices 34 can also be integrated with other existing information or transaction systems, such as inventory control devices and systems, point-of-sale devices and systems, or the like. The premises server 32 also communicates with one or more output devices 36. In an illustrative embodiment, the output devices 36 can include audio speakers, display or other audio/visual displays. The output devices 36 may also include electrical or electromechanical devices that allow the system to perform actions. As will be readily understood by one skilled in the art, the type of output device is associated primarily with the type of action the information system 30 produces. In accordance with the present invention, the monitoring devices 34 and the output devices 36 can be linked together in a computer network environment in which multiple premises servers 32 work in parallel, sharing data and processes. Moreover, additional premises servers 32, monitoring devices 34, and output devices 36 may be joined modularly to provide extensibility to the system 30.

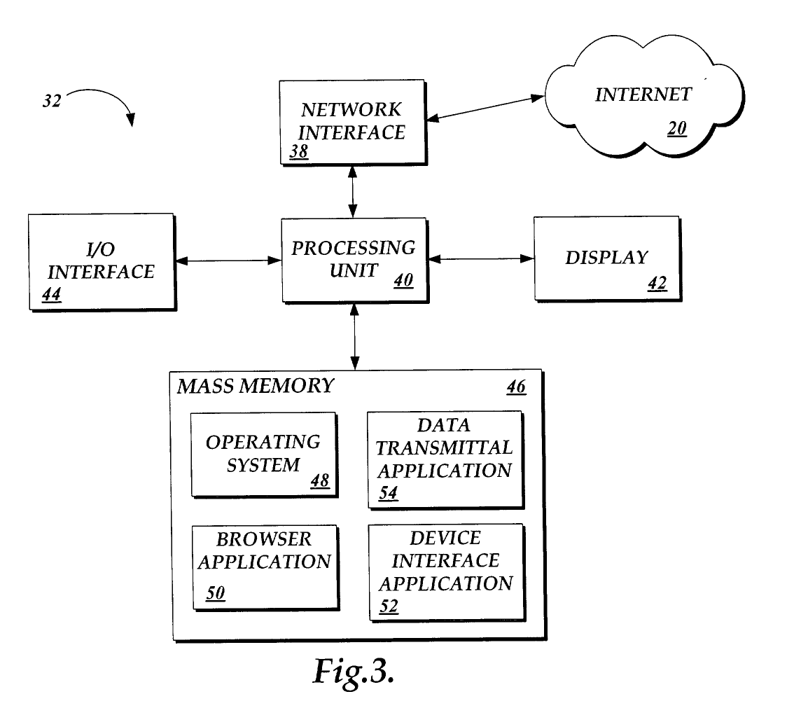

FIG. 3 is a block diagram depicting an illustrative architecture for a premises server 32. Those of ordinary skill in the art will appreciate that the premises server 32 includes many more components then those shown in FIG. 3. However, it is not necessary that all of these generally conventional components be shown in order to disclose an illustrative embodiment for practicing the present invention. As shown in FIG. 3, the premises server 32 includes a network interface 38 for connecting directly to a LAN or a WAN, or for connecting remotely to a LAN or WAN. Those of ordinary skill in the art will appreciate that the network includes the necessary circuitry for such a connection, and is also constructed for use with the TCP/IP protocol, the particular network configuration of the LAN or WAN it is connecting to, and a particular type of coupling medium. The premises server 32 may also be equipped with a modem for connecting to the Internet through a point-to-point protocol (“PPP”) connection or a serial-line Internet protocol (“SLIP”) connection as known to those skilled in the art.

The premises server 32 also includes a processing unit 40, a display 42, an input/output (I/O) interface 44 and a mass memory 46, all connected via a communication bus, or other communication device. The I/O interface 44 includes hardware and software components that facilitate interaction with a variety of the monitoring devices via a variety of communication protocols including TCP/IP, X10, digital I/O, RS-232, RS-485 and the like. Additionally, the I/O interface 44 facilitates communication via a variety of communication mediums including telephone landlines, wireless networks (including cellular, digital and radio networks), cable networks and the like. In an actual embodiment of the present invention, the I/O interface is implemented as a layer between the server hardware and software applications utilized to control the individual monitoring devices 84 and output devices 36. It will be understood by one skilled in the relevant art that alternative interface configurations may be practiced with the present invention.

The mass memory 46 generally comprises a RAM, ROM, and a permanent mass storage device, such as a hard disk drive, tape drive, optical drive, floppy disk drive, or combination thereof. The mass memory 46 stores an operating system 48 for controlling the operation of the premises server. It will appreciated that this component may comprises a general-purpose server operating system as is known to those skilled in the art, such as UNIX, LINUX™, or Microsoft WINDOWS NT®. The memory may also include a Web browser 50, such as Netscape's NAVIGATOR® or Microsoft's Internet Explorer browsers, for accessing the WWW, and encryption software components such as secure socket layer (“SSL”) or secure shell encryption software (“SSH”).

The mass memory 46 also stores program code and data for interfacing with various premises monitoring devices, for processing the monitoring device data and for transmitting the data to a central server. More specifically, the mass memory stores a device interface application 52 in accordance with the present invention for obtaining monitoring device data from a variety of devices and for manipulating the data for processing by other components of the information processing system 30. The device interface application 52 comprises computer-executable instructions which, when executed by the premises server 32 obtains and transmits device data as will be explained below in greater detail. The mass memory 46 also stores a data transmittal application program 54 for facilitating communication between various components of the information processing system 30. In one embodiment of the present invention, the data transmittal application 54 may communicate with other components in the integrated information system 30 in conjunction with the Web browser 50. Alternatively, the data transmittal application 54 may communicate directly with other components as a standalone application. The operation of the data transmittal application 54 will be described in greater detail below. It will be appreciated that these components may be stored on a computer-readable medium and loaded into the memory of the premises server using a drive mechanism associated with the computer-readable medium, such as a floppy, CD-ROM, DVD-ROM drive, or network drive 38.

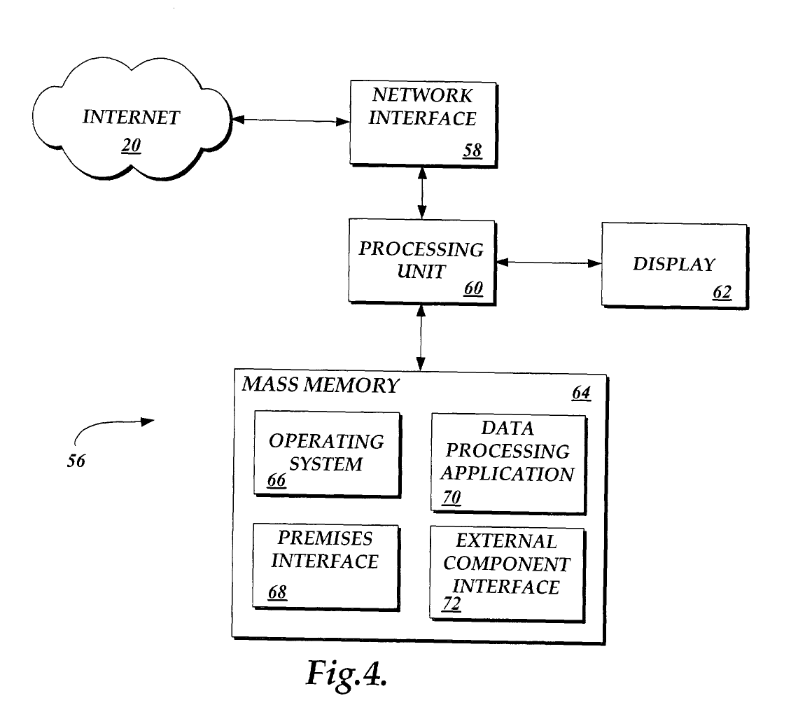

Returning to FIG. 2, the premises server 32 is in communication with a central server 56. Generally described, the central server 56 obtains various monitoring device data, processes the monitoring data according to processing rules, generates any outputs, and interfaces with any external components of the system 30. In an illustrative embodiment, the communication between the central server 56 and the premises server 32 is remote and two-way. Further, the transmissions may be encrypted, compressed, or otherwise processed. It will be understood by one skilled in the relevant art that the premises server 32 may be remote from the premises or may omitted altogether. In such an alternative embodiment, the monitoring devices 34 transmit the monitoring data to a remote premises server 32 or alternatively, they transmit the monitoring data directly to the central server 56. FIG. 4 is a block diagram depicting an illustrative architecture for a central server 56. Those of ordinary skill in the art will appreciate that the central server 56 includes many more components then those shown in FIG. 4. However, it is not necessary that all of these generally conventional components be shown in order to disclose an illustrative embodiment for practicing the present invention.

As shown in FIG. 4, the central server 56 includes a network interface 58 for connecting directly to a LAN or a WAN, or for connecting remotely to a LAN or WAN. Those of ordinary skill in the art will appreciate that the network interface includes the necessary circuitry for such a connection, and is also constructed for use with the TCP/IP protocol, the particular network configuration of the LAN or WAN it is connecting to, and a particular type of coupling medium. The central server 56 may also be equipped with a modem for connecting to the Internet 20.

The central server 56 also includes a processing unit 60, a display 62 and a mass memory 64, all connected via a communication bus, or other communication device. The mass memory 64 generally comprises a RAM, ROM, and a permanent mass storage device, such as a hard disk drive, tape drive, optical drive, floppy disk drive, or combination thereof. The mass memory 64 stores an operating system 66 for controlling the operation of the central server. It will be appreciated that this component may comprise a general-purpose server operating system. The mass memory may also include encryption software components such as SSL or SSH.

The mass memory 64 also stores program code and data for interfacing with the premises devices, for processing the device data and for interfacing with various authorized users. More specifically, the mass memory 64 stores a premises interface application 68 in accordance with the present invention for obtaining data from a variety of monitoring devices and for communicating with the premises server. The premises interface application 68 comprises computer-executable instructions that, when executed by the central server 56, interface with the premises server 32 as will be explained below in greater detail. The mass memory 64 also stores a data processing application 70 for processing monitoring device data in accordance with rules maintained within the central server. The operation of the data processing application 70 will be described in greater detail below. The mass memory 64 further stores an external component interface application 72 for communicating with external components of the system to obtain external event determinations and for outputting the processed monitoring device data to a variety of authorized external components. The operation of the external component interface application 72 will be described in greater detail below. It will be appreciated that these components may be stored on a computer-readable medium and loaded into the memory of the central server using a drive mechanism associated with the computer-readable medium.

Also in communication with the central server 56 is a central database 74. In an illustrative embodiment, the central database 74 includes a variety of databases including an event logs database 76, an asset rules database 78, a resource rules database 80, an asset inventory database 82, a resource inventory database 84, an event rules database 86 and an active events database 88. The utilization of the individual databases within the central database 74 will be explained in greater detail below. As will be readily understood by one skilled in the relevant art, the central database 74 may be one or more databases, which may be remote from one another. Additionally, it will be further understood that one or more of the databases 74 may be maintained outside of the central server 56.

With continued reference to FIG. 2, the central server 56 communicates with one or more external components 90. In an illustrative embodiment, the external components 90 can include one or more authorized users for receiving outputs from the central server 56. Each authorized user has a preference of notification means as well as rights to the raw and processed monitoring data. The authorized users include premises owners, security directors or administrators, on-site security guards, technicians, remote monitors (including certified and non-certified monitors), customer service representatives, emergency personnel and others. As will be readily understood by one skilled in the art, various user authorizations may be practiced with the present invention. Additionally, it will be further understood that one or more of the rules databases may be maintained outside of the central server.

The central server 56 can communicate with the external components 90 utilizing various communication devices and communication mediums. The devices include personal computers, hand-held computing devices, wireless application protocol enabled wireless devices, cellular or digital telephones, digital pagers, and the like. Moreover, the central server 56 may communicate with these devices via the Internet 20 utilizing electronic messaging or Web access, via wireless transmissions utilizing the wireless application protocol, short message services, audio transmission, and the like. As will be readily understood by one skilled in the art, the specific implementation of the communication mediums may require additional or alternative components to be practiced. All are considered to be within the scope of practicing the present invention.

In another embodiment, of the present invention the external components 90 can include one or more users, systems and/or devices for generating external event determinants and output specifications for at least one monitored premises. In one illustrated embodiment of the present invention, the external components 90 providing external event determinants may overlap with the authorized users receiving outputs from the integrated information system 30. The external component 90 can include on-premises security guards, remote monitors, independent monitoring systems, non-integrated monitoring devices and the like. As described above, the external components 90 may communicate with the central server 54 in a variety of manners and/or communication format. Further, the external components 90 may communicate directly with the premises server 32.

Generally described, the present invention facilitates the collection and processing of premises information by the integrated information system 30. The system of the present invention obtains monitoring data from any one of a variety of monitoring devices 34. In an actual embodiment of the present invention, the monitoring device data is categorized as asset data, resource data, or event data. Asset data is obtained from a monitoring device corresponding to an identifiable object that is not capable of independent action. For example, asset data includes data obtained from a bar code or transponder identifying a particular object, such as a computer, in a particular location. Resource data is obtained from a monitoring device corresponding to an identifiable object that is capable of independent action. For example, resource data includes data from a magnetic card reader that identifies a particular person who has entered the premises. Event data is obtained from a monitoring device corresponding to an on/off state that is not correlated to an identifiable object. Event data is a default category for all of the monitoring devices. As will be readily understood by one skilled in the relevant art, alternative data categorizations are considered to be within the scope of the present invention.

The monitoring device data can be processed (e.g., encrypted, compressed, etc.) and transmitted to the central server 56. The central server 56 receives the monitoring device data and processes the data according to a rules-based decision support logic. In an actual embodiment of the present invention, the central server 56 maintains databases 74 having logic rules for asset data, resource data and event data. Moreover, because the monitoring device data is potentially applicable to more than one authorized user, multiple rules may be applied to the same monitoring device data. In an alternative embodiment, the rules databases 74 may be maintained in locations remote from the central server 56. Further, the logic rules may be predefined by the system 30 or by customized users. Alternatively, the logic rules may be dynamically specified during he operation of the system 30.

In the event the processing of the monitoring device rules indicates that action is required, the central server 56 generates one or more outputs associated with the rules. The outputs include communication with indicated external component 90 according to the monitoring device data rules. In one aspect, an authorized user may indicate a hierarchy of communication mediums (such as pager, mobile telephone, land-line telephone) that should be utilized in attempting to personally contact the user. The rules may also indicate contingency contacts in the event the authorized user cannot be contacted. Additionally, the rules may limit the type and/or amount of data to which the user is allowed to access. In another aspect the outputs can include the initiation of actions by the central server 56 in response to the processing of the rules. For example, an audio alarm may be sounded (output device 36) in response to the same rule violation.

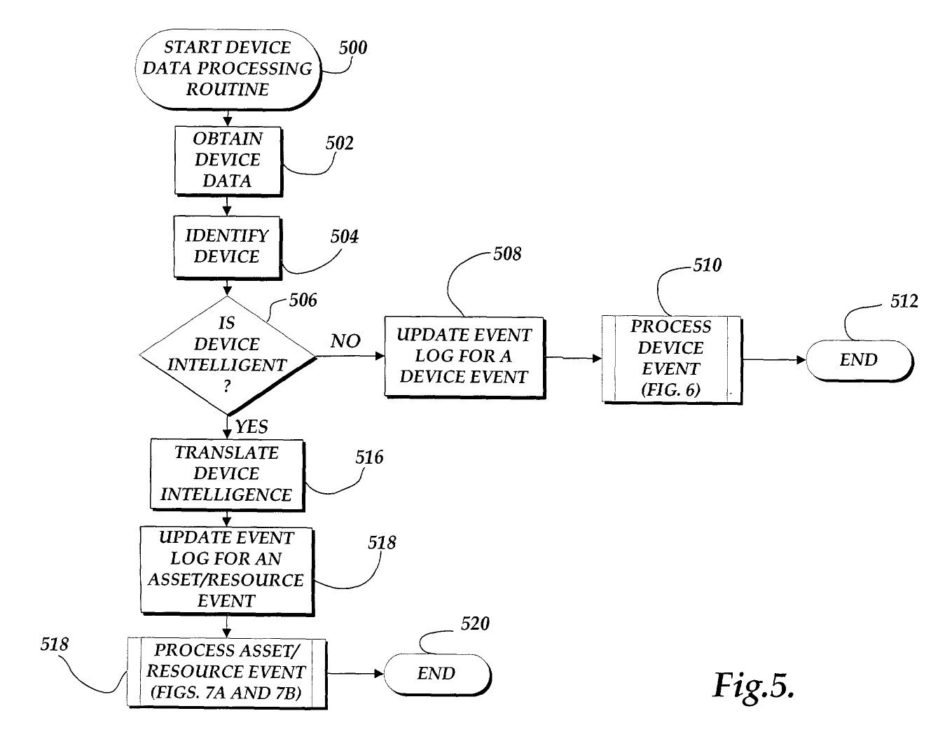

FIG. 5 is a flow diagram illustrative of a device decision support routine 500 for processing the monitoring device data in accordance with the present invention. At block 502, the central server 56 obtains an input from a monitoring device. In an actual embodiment of the present invention, the input is obtained from the premises server 32. Alternatively, the input may be received directly from the monitoring device 34 or the central server 56 may poll individual devices (or the premises server 32) for an input. At block 504, the central server 56 identifies the device processing the data. The identification may be accomplished by determining a network address from which the input originated and which is assigned to the specific devices, or by reading other identification data that can be included with the data input.

At decision block 506, a test is performed to determine whether the device data includes intelligence data. In an actual embodiment of the present invention, the intelligence data includes data that characterizes the data as asset data or resource data, because the data contains information identifying the object. In contrast, data that does not contain any information identifying an object and is not considered intelligent. If the device is not determined to be intelligent or if the device cannot be identified, at block 508, an event log database 76 is updated to reflect the input data. At block 510, the central server 56 processes the data according to a process device event subroutine. The routine 500 terminates at block 512.

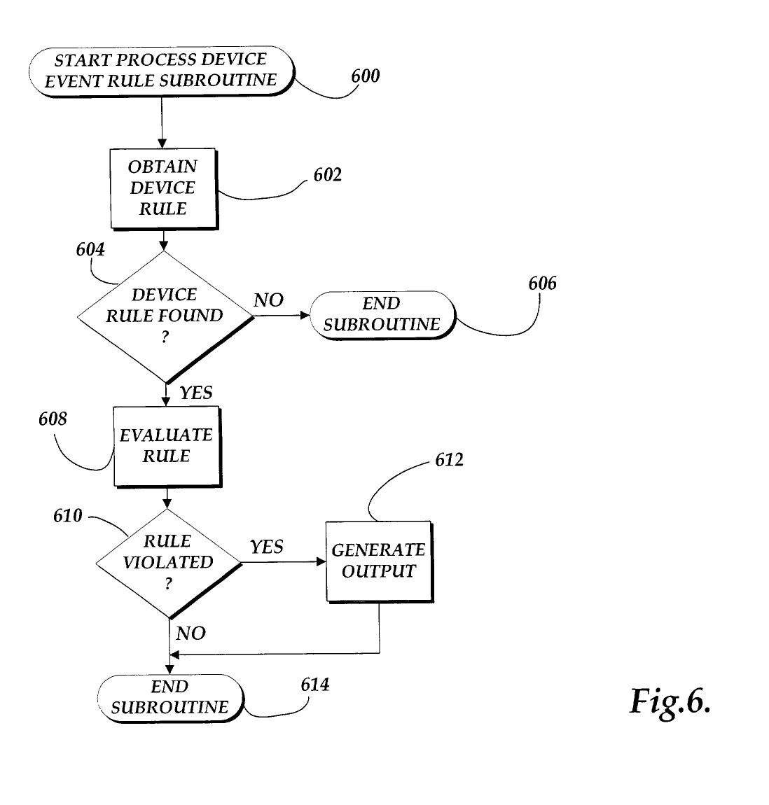

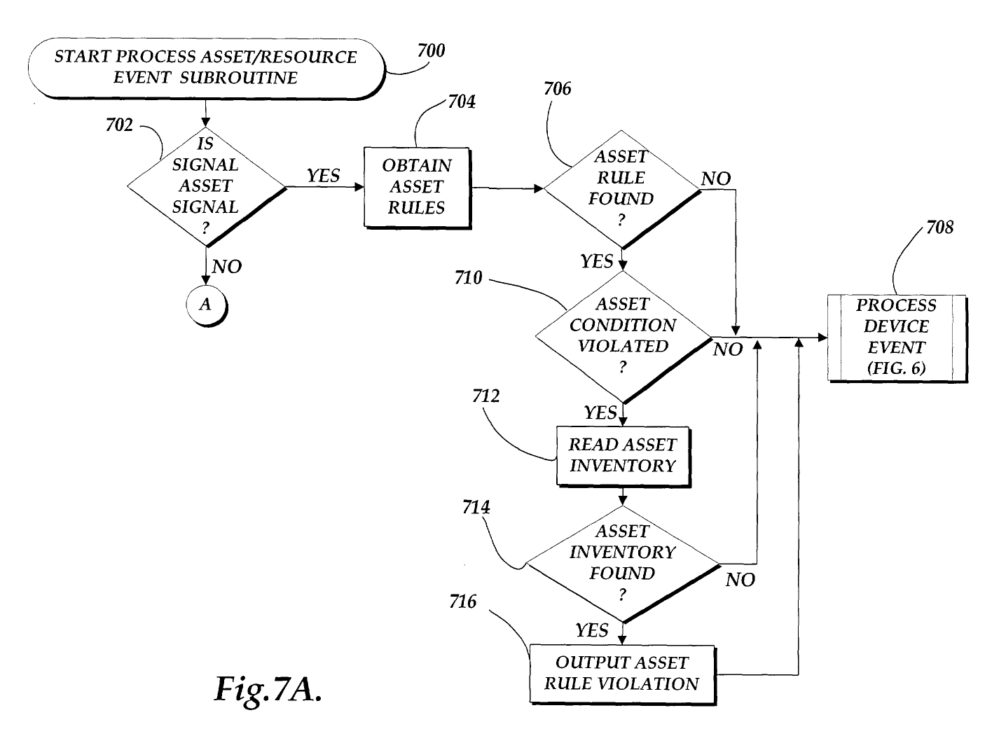

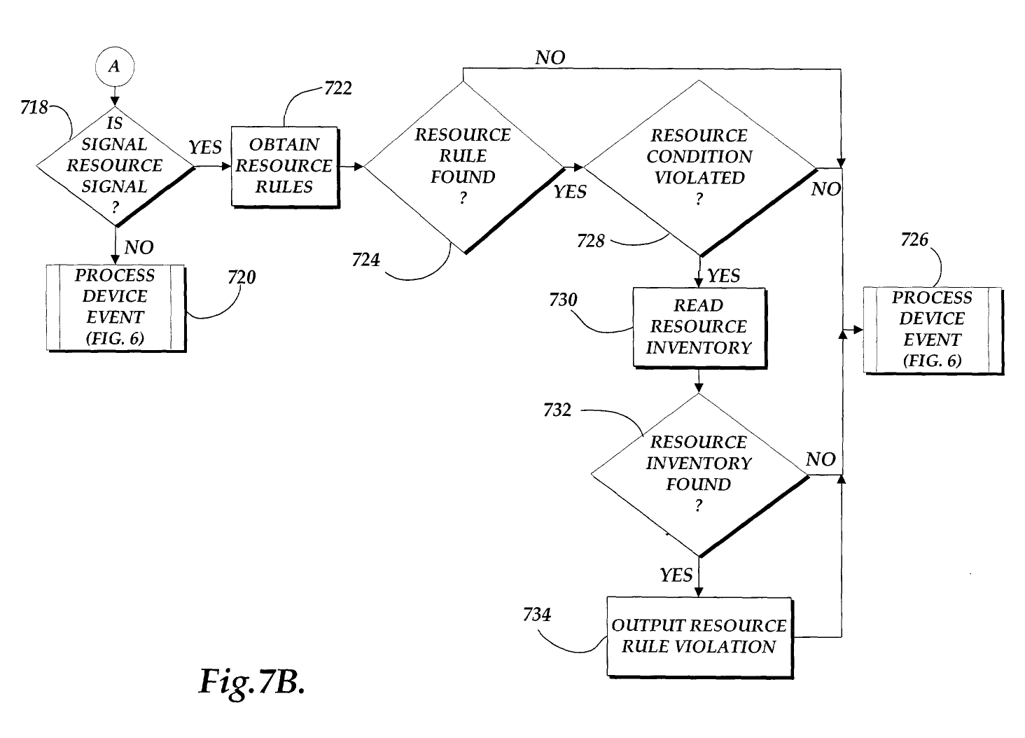

FIG. 6 is a flow diagram illustrative of a process device event subroutine 600 in accordance with the present invention. At block 602, the central server 56 obtains the monitoring device rules. In an actual embodiment, the monitoring device rules are stored in a database 86 in communication with the central server 56. The rules contain data indicating one or more ranges for determining a rule violation. In a broad sense, a rule violation is an indication of an event occurrence for which a notification is required. The ranges correspond to the type of data produced by the monitoring device. For example, if a monitoring device 34 is capable of only two stages (e.g., on or off), the rule may indicate that existence of one stage, e.g., “on”, is a violation. The rules may also include an indication that one or more monitoring device rules must also be processed before the rule can be determined to have been violated. For example, a rule corresponding to a glass break detector may indicate that a motion detector signal must be detected before the rule is violated. As will be readily understood by one skilled in the relevant art, additional or alternative rule types are considered to be within the scope of the present invention.

At decision block 604 a test is performed to determine whether a device rule is found. If no rule is found, the process terminates at block 606. If, however, a device rule is found, at block 608 the central server 56 evaluates the rule according to the data received from the monitoring device 34. In an illustrative embodiment, the rules may include preset or default rules maintained by the central server 56. Additionally, the rules may include independently created rules by one or more authorized users. Moreover, one or more authorized users may be given the authority to modify or update rules via a user interface.

At decision block 610, a test is performed to determine whether the device rule is violated. If the rule is violated, at block 612, the central server 56 creates a rule violation output. In an actual embodiment of the present invention, the rules violation output instructions may be included in the rule. The instructions include a list of the authorized users to notify in the event of a rule violation and a hierarchy of which communication medium and devices should be utilized to contact each authorized user. For example, the rules may be in the form of logical if/then statements implementing an iterative hierarchy for establishing communication with an authorized user. Moreover, the instructions may also indicate the data a user may have access to. For example, the output may include the generation of a call to the premises owner's mobile device, the paging of an on-site monitor and a land-line telephone call to the public authorities. Alternatively, the central server may also maintain an output database indicating the output instructions corresponding to each rule.

In an illustrative embodiment of the present invention, the communication from the central server 56 may be to a wireless computing device, such as a personal digital assistant, or mobile phone. In accordance with this aspect of the present invention, the central server 56 maintains an output server for generating output to a wireless device. In an illustrative embodiment of the present invention, the output server would include a database for formatting the output to the specific requirements of a device selected by the external component 90. Alternatively, the output server may also maintain a standard image including a minimum set of display characteristics that match most mobile computing device displays.

In another illustrative embodiment of the present invention, the rules violation output may be in the form of an output over a telecommunications or IP network. Moreover, in the event the external component 90 requests an audible notification, text to speech components may be utilized to translate electronic data into an audible form. Accordingly, because the notification hierarchy may specify one or more notifications, the same electronic data is processed to allow for display by a first device and an audible projection by a second device.

In addition to generating communications, the rules violation output may also instigate an integrated system response. For example, in the case of an intrusion, a dye may be sprayed on the intruder from an aerosol sprayer. Additionally, the system may sound an audible alarm and directly dial emergency personnel. In another example, if the system rules violation is a medical emergency, the central server 56 may call an ambulance, turn on lights within the premises, and unlock the doors to facilitate entry by the emergency personnel.

Once the central server 56 has generated the rules violation output at block 612 or if the event rule is not violated at block 610, the subroutine 600 terminates at block 614.

Returning to FIG. 5, if at block 506, the device data includes intelligence information, at block 514, the intelligence is translated from the monitoring device data. At block 516, the log event database 76 is updated to reflect the input data. At block 518, the central server 56 processes the data according to a process asset/resource event subroutine. The routine 500 terminates at block 520.

FIGS. 7A and 7B are flow diagrams illustrative of a process asset or resource event subroutine 700 in accordance with the present invention. With reference to FIG. 7A, at decision block 702, a test is performed to determine whether the input signal is asset data. If the signal is identified as asset data, at block 704, the asset rules are obtained. In an actual embodiment of the present invention, the asset rules are maintained and retrieved from an asset rules database 78. At block 706, a test is performed to determine whether an asset rule is found. If no asset rule is found for the asset, the monitoring device data is processed as a device event at block 708. In an actual application of the present invention, the device event is processed as described above with respect to the device event processing subroutine 600 (FIG. 6). In an illustrative embodiment of the present application, in the event the asset rule processing cannot be completed, the monitoring device is still processed as a device-level event.

If an asset rule is found, at decision block 710, a test is performed to determine whether the asset rule is violated. In an actual embodiment of the present invention, the asset rule contains data allowing the central server 56 to determine a rule violation. For example, an asset rule may contain information indicating a requirement of a particular object (e.g., a computer) performing an action (e.g., logged into a network) for a violation. Additionally, the asset rule may indicate that additional device, resource or asset rules may be considered prior to determining whether the rule has been violated. As explained above, the rules may include preset rules maintained by the central server and user implemented/modified rules.

If the rule has not been violated, the monitoring device data is processed as a device event at block 708. It will be generally understood by one skilled in the relevant art, that processing the rule as a both an asset and a device event allows for multiple purpose processing of the monitoring device data, such as the detection of a specific object and the detection of an object.

If the asset rule has been violated, at block 712, the central server 56 reads a known asset inventory to identify the asset. In an actual embodiment of the present invention, central server maintains and reads from an asset inventory database 82. At decision block 714, a test is performed to determine whether the asset is found in the asset inventory. If the asset is not found, the system defaults to processing the monitoring device data as a device event at block 708. If the asset is found in the asset inventory, at block 716, central server 56 outputs the asset violation. In an actual embodiment of the present invention, the asset rule contains instructions for generating output in the event of a rule violation to one or more authorized users. The instructions also contain a hierarchy of communication mediums and communication devices to attempt to contact the authorized user. Additionally, the instructions may contain alternative contact personnel if central server cannot contact the authorized user. Moreover, as explained above, the output may also instigate action by the integrated system. At block 708, the monitoring device data is processed as a device event.

With reference to FIG. 7B, if the signal is not determined to be asset data at block 702 (FIG. 7A), at decision block 718, a test is done to determine whether the inputted signal is resource data. If the signal is not identified as resource data, at block 720, the monitoring device data is processed as a device event. In an actual application of the present invention, the device event is processed as described above with respect to the device event processing subroutine 600 (FIG. 6). If the signal is identified as resource data, at block 722, the resource rules are obtained. In an actual embodiment of the present invention, the resource rules are maintained and retrieved from a resource rules database 80. At block 724, a test is performed to determine whether a resource rule is found. If no resource rule is found for the resource, the monitoring device data is processed as a device event at block 726.

If a resource rule is found, at decision block 728, a test is performed to determine whether the resource rule is violated. In an actual embodiment of the present invention, the resource rule contains data allowing the central server to determine a rule violation. Additionally, the resource rule may indicate that additional device, resource or asset rules may be considered prior to determining whether the rule has been violated. If the rule has not been violated, at block 726, the monitoring device data is processed as a device event. It will be generally understood by one skilled in the relevant art, that processing the rule as a both a resource and a device event allows for multiple purpose processing of the monitoring device data.

If the resource rule has been violated, at block 730, the central server 56 reads a known resource inventory to identify the resource. In an actual embodiment of the present invention, central server 56 maintains and reads from a resource inventory database 84. At decision block 732, a test is performed to determine whether the resource is found in the resource inventory. If the resource is not found, the system defaults to processing the monitoring device data as a device event at block 726. If the resource is found in the resource inventory, at block 734, central server 56 outputs the resource violation. In an actual embodiment of the present invention, the resource rule contains instructions for generating output in the event of a rule violation to one or more authorized users. The instructions also contain a hierarchy of communication mediums and communication devices to attempt to contact the authorized user. Additionally, the instructions may contain alternative contact personnel if central server 56 cannot contact the authorized user. Moreover, as explained above, the output may also instigate action by the integrated system. At block 726, the monitoring device data is processed as a device event.

In an actual embodiment of the present invention, portions of a user interface with the integrated information system 30 are displayed remotely from one or more of the servers. For example, an authorized user, such as the premises owner, may be available to view an event violation remotely through the use of an Internet connection. In another embodiment, a remote monitoring service may be given access to control one or more of the monitoring devices 34 via an Internet-based connection or via a direct communication line. Still further, security personnel may review real time monitoring device 34 data via a wireless communication device. Accordingly, the user interface provided to the authorized user may conform to the function being performed, the limits of a device, or the communication medium transmitting the data.

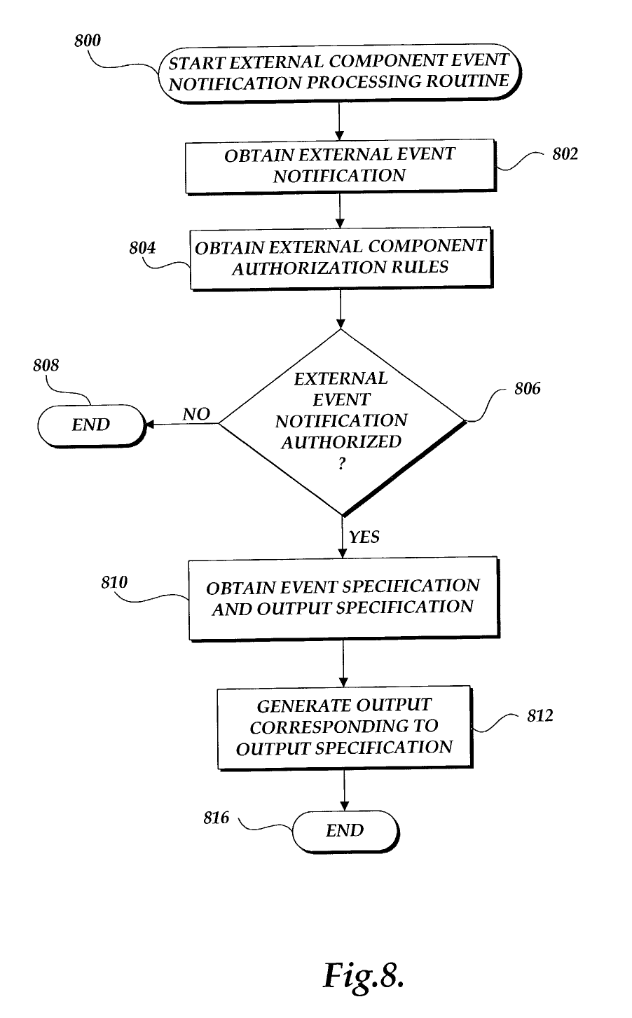

In addition to the processing of monitoring device data, the integrated information system 30 also facilitates the ability to obtain external event determinations from an external component 90. FIG. 8 is a flow diagram illustrative of an external event determination processing subroutine 800 in accordance with the present invention. At block 802, the central server obtains an external event notification. In an illustrative embodiment of the present invention, the external event notification may originate from any number of external components 90. In one aspect, the external component 90 can include a security guard that utilizes a computing device interface or other communication device, to notify central server of an external event. In another aspect, the external component 90 can include an external monitor remote from the premises that can utilize the computing device or other communication can interface with the central server 56 to provide the notification of an external event. In still another aspect, the external component 90 can include any monitoring or information system that is not otherwise directly connected to the integrated information system 30, but that can provide some type of event notification to the central server 56. For example, the external component 90 can include a self-contained motion detection unit placed within a premises, that includes some type of notification to the central server 56.

At block 804, the central server 56 obtains one or more external event authorization rules. In an illustrative embodiment of the present invention, the external event authorization rules may be stored in database 86 that is in communication with central server 56. For example, the external event authorization rules may be treated as equivalent instances of a device rule, or a resource rule, and the like. The external event authorization rules can establish various criteria identifying which external components 90 have authorization to establish an external event notification, and one or more parameters associated with the authorization for the external components. For example, one external component 90, such as a security guard, may have authorization to instigate an unlimited number of event notifications, but only during particular hours of the day. In another example, a particular external component 90, such as a remote monitor, may only have authorization to establish a particular type of event notification. In a further example, some external components, may be authorized to receive processed event rule violations, without having authorization to make an external event determination. In yet another example, a external component identifier may be utilized to determine whether the component is authorized to transmit a external event notification. In one aspect, an external component 90 may be associated with a particular communication identifier, such as an Internet Protocol (“I.P.”) address. Accordingly, the external event notification can be associated with the identifier. In another aspect, the external component may pass an identifier, or set of identifiers, together with the external event notification.

At decision block 806, a test is conducted to determine whether the external event notification is authorized by the external event authorization rules. If no rule can be found, or if the external component 90 is not authorized to instigate an external event notification, the routine 900 terminates at block 808. Alternatively, if the external event notification is authorized, the central server 56 obtains an event specification and output specification at block 810. In an illustrative embodiment of the present invention, the initial event notification can include detailed information of a type of event notification and any other details associated with the determination of an external event. Additionally, the external event notification can include a selection of one or more predetermined outputs corresponding to the determined external event, or a specification of a manual output to be done by the integrated information system 30. For example, the user may be presented with a user interface that establishes a hierarchy of communication, media and output devices 36 that should be utilized to generate an output on a determined event violation. Further, the event notification can include additional information for follow-up, or heightened security state of monitoring that may affect the overall processing of monitoring device data by the integrated information system 30. If any of the event specification and/or output specification data was not originally provided, the central system 56 can poll the external component 90 to obtain additional information.

At block 812, the central server generates outputs corresponding to the determined event. As described above, outputs generated by the integrated information system 30 can include any number of physical activities within the premises, and the generation of communications to any number of authorized user external components 90. Further, the central system 56 can maintain a log of external event determinations that provides information of the external component 90 that generated the external event, and the affected areas in or monitoring device 34, and any additional notes provided by the external component during the event determination. At block 814, the routine 800 terminates.

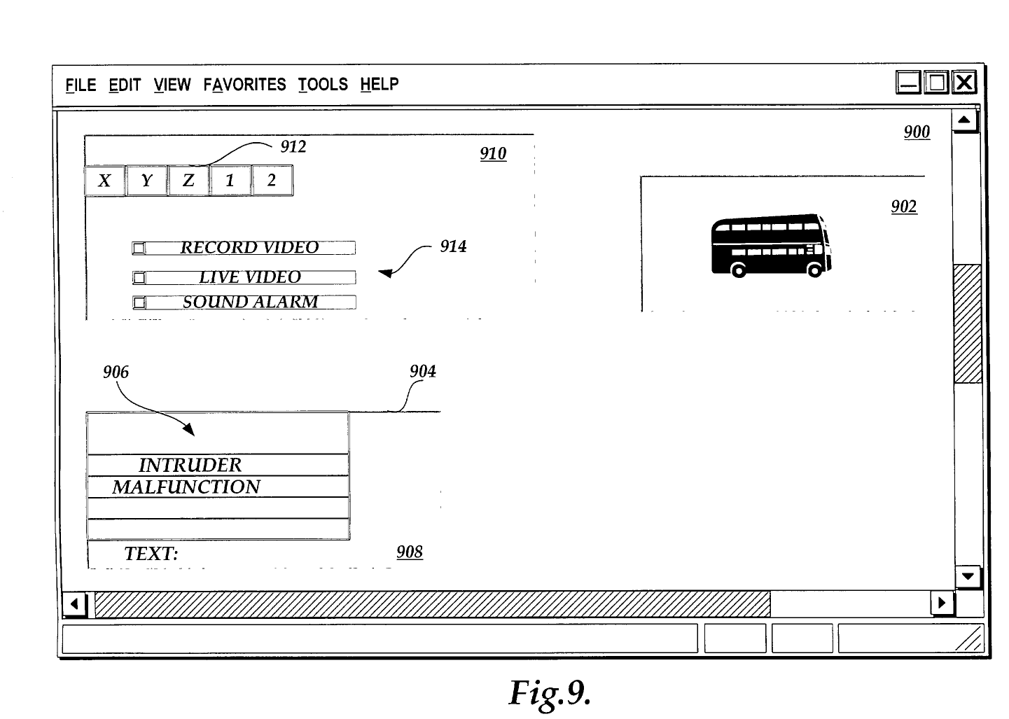

FIG. 9 is illustrative of a screen display 900 facilitating the initiation of an external event determination by an external component 90 in accordance with the present invention. The screen display 900 includes a first rectangular viewing area 902 that provides monitoring device data. For example, the external viewing area can include digital video data from video monitoring devices 34. Additionally, the viewing area 902 can include textual information, such as log files, and/or any additional information provided by any one of the monitoring devices included in the information processing system. Moreover, there may be any number of viewing areas 902 provided to an authorized external component 90.

The screen interface 900 also includes an event determination display 904 for allowing an external component 90 to assign or specify a particular event type. As illustrated in FIG. 9, the event determination component 904 can include a pull-down menu 906 that allows an external component 90 to select from any number of preselected event conditions. An illustrative embodiment of the present invention, the pull-down menu may be limited to the particular external component 90 that is logged into the system. Additionally, the event determination component 904 can also include a number of textual fields for entering additional data describing the event, or specifying a particular event not included in the pull-down menu.

The screen display 900 also includes an output specification component 910 that allows for the selection of outputs generated by the system. The output control generation control 910 can include a number of control tabs 912 for specifying one or more output devices to be activated by the integrated information system 30. As illustrated in FIG. 9, it can include a camera selection component 914 that allows a user to specify a particular monitoring device 34, such as a camera, to begin recording data or just providing live video data. In an illustrative embodiment of the present invention, the output control section 910 can be limited by the selection of a particular event, such that the user will only be allowed to select certain outputs depending on what type of external event was selected. Although FIG. 9 is illustrative of an embodiment of the present invention, one skilled in the art will appreciate that it is illustrative in nature and should not be construed as limiting.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. In an integrated information system having at least one monitoring device providing monitoring device data, a method for providing an external event determination, wherein the integrated information system includes at least one processing rule for processing monitoring device data, the method comprising:
obtaining monitoring device data corresponding to a monitored target and at least one processing rule corresponding to the monitoring device data;
processing the monitoring device data according to the at least one processing rule;
obtaining an external event notification corresponding to the monitored target;
processing the external event notification to determine an event and an integrated information system output; and
generating an output corresponding to the processing of the external event notification, wherein the output may include no output.

2. The method as recited in claim 1, wherein obtaining an external event notification includes obtaining an external event notification from an external component, and wherein processing an external event notification includes determining whether the external component has authorization to make an external event notification.

3. The method as recited in claim 2, wherein determining whether the external component has authorization to make an external event notification includes:
identifying an Internet Protocol address corresponding to the external component; and
determining whether an event notification is authorized from the Internet Protocol address.

4. The method as recited in claim 2, wherein determining whether the external component has authorization to make an external event notification includes associating a set of allowable event notifications to the external component, and determining whether a specified external event notification corresponds to the set of allowable external event notifications.

5. The method as recited in claim 1, wherein processing the monitoring device data according to the at least one processing rule includes determining that an event has not occurred.

6. The method as recited in claim 1, wherein generating an output includes capturing video monitoring device data corresponding to the external event notification.

7. The method as recited in claim 1, wherein the integrated information system includes at least one output device and wherein generating an output includes activating an output device corresponding to a monitored premises.

8. The method as recited in claim 1, wherein generating an output includes generating a record including information identifying an event and an external component transmitting the external event notification.

9. The method as recited in claim 1, wherein obtaining an external event notification includes obtaining an external event notification from an external user component.

10. The method as recited in claim 9, wherein the external user component is remote from the monitored target.

11. The method as recited in claim 1, wherein obtaining an external event notification includes obtaining an external event notification from an external device.

12. The method as recited in claim 1, wherein obtaining an external event notification includes obtaining information identifying a severity level for an event determination.

13. The method as recited in claim 1, wherein generating an output includes a user interface including at least one access point to data associated with the external event notification.

14. The method as recited in claim 13, wherein the data associated with the external event notification includes at least a portion of the monitoring device data.

15. The method as recited in claim 1, wherein obtaining an external event notification includes obtaining an itemized list of actions required to resolve a specified event.

16. The method as recited in claim 1, wherein generating an output includes notifying at least one external component using a designated communication medium.

17. The method as recited in claim 16, further comprising obtaining an external component notification failure and wherein generating output includes escalating notification of the at least one external component.

18. The method as recited in claim 1 further comprising transmitting the monitoring device data to an external component.

19. The method as recited in claim 1, wherein obtaining an external event notification includes:
generating a user interface for obtaining an event notification from an external component user; and
obtaining an event notification from the user interface.

20. The method as recited in claim 1, wherein the monitored target is a premises.

21. A computer-readable medium having computer-executable instructions operable for performing the method recited in claim 1.

22. A computer system having an operating system, a processor, and a memory, the computer system operable to perform the method as recited in claim 1.

23. A system for providing device monitoring, the system comprising:
a processing component having at least one monitoring device providing monitoring device data for a monitored target and at least one processing rule corresponding to the monitoring device, wherein the processing component processes the monitoring device data according to the processing rule;
at least one external component operable to provide external event notification data corresponding to the monitoring device data to the processing component;
wherein the processing component processes the external event notification data to determine a monitoring event and a corresponding output.

24. The system as recited in claim 23, wherein the external component is an external user component.

25. The system as recited in claim 24, wherein the external user component is remote from the monitored target.

26. The system as recited in claim 23, wherein the external component is an external device.

27. The system as recited in claim 23, wherein the processing component determines whether the at least one external component has authorization to make an external event notification.

28. The system as recited in claim 23 wherein the corresponding output includes capturing video device data corresponding to the external event notification data.

29. The system as recited in claim 23, wherein the system includes at least one output device and wherein the corresponding output includes activating the at least one output device corresponding to the external event notification data.

30. The system as recited in claim 23, wherein the corresponding output includes generating a record identifying an event and an external component transmitting the external event notification data.

31. The system as recited in claim 23, wherein the external event notification data identifies a severity level of a designated event.

32. The system as recited in claim 23, wherein the external event notification date identifies one or more outputs for the processing component.

33. The system as recited in claim 23, wherein the processing component transmits the monitoring device data to the at least one external component.

34. The system as recited in claim 23, wherein the processing component generates a screen display for obtaining external event notification data from the at least one external component.

35. In a computer system having a display and an interface device, a method for managing external event determinations for an integrated information system, wherein the integrated information system includes at least one monitoring device generating monitoring device data and at least one processing rule corresponding to the monitoring device data, the method comprising:
obtaining a set of authorized external event notifications corresponding to an external component user;
displaying the set of authorized external event notifications on the display;
obtaining a user selection of an external event notification; and
transmitting the user selection of the user event notification.

36. The method as recited in claim 35, wherein the set of external event notifications include an identification of an event and a specification of an output for the integrated information system.

37. The method as recited in claim 36, wherein the specification of an output includes capturing video device data.

38. The method as recited in claim 36, wherein the specification of an output includes activating of one or more output devices corresponding to the integrated information system.

39. The method as recited in claim 36, wherein the specification of an output includes generating a record identifying an external component transmitting external event notification.

40. The method as recited in claim 36, wherein the specification of an output includes specifying a severity level for the user event notification.

41. The method as recited in claim 36, wherein the specification of an output includes notifying one or more external components utilizing a designated notification medium.

42. A computer-readable medium having computer-executable instructions operable for performing the method recited in claim 35.
